(19) United States
(12) Patent Application Publication
(10) Pub. No.: US 2003/0217502 A1
(43) Pub. Date: Nov. 27, 2003

(54) Sink line for fishing net

(76) Inventor: Jens Conrad Hansen, Rodvig Stevns (DK)

Correspondence Address: Welsh & Katz, Ltd., 22nd Floor, 120 South Riverside Plaza, Chicago, IL, 60606, US

(21) Appl. No.: 10/410,591

(22) Filed: Apr. 4, 2003

Related U.S. Application Data
(63) Continuation of application No. PCT/DK01/00645, filed on Oct. 4, 2001.

(30) Foreign Application Priority Data
Oct. 4, 2000 (DK) PA 2000 01470
May 23, 2001 (DK) PA 2001 00818

(51) Int. Cl. A01K 91/00; B28B 1/00; C04B 33/32

(52) U.S. Cl. 43/43.14; 264/632

(57) ABSTRACT

The sink line comprises a plurality of weights attached to a longitudinal supporting structure, preferably in a spaced a part relationship, the weights comprising a core member of a first material entirely enclosed in a coating of a second material, the weights having an outer surface in securing engagement with the supporting structure.

### FIELD OF THE INVENTION

The present invention relates to a sink line primarily for a fishing net, the sink line being in the form of a ribbon or band like structure having a weight making it suitable for attachment to a lower portion of a fishing net thereby securing the desired orientation of the fishing net when deployed in water.

### BACKGROUND OF THE INVENTION

Fishing nets are normally configured to have a given predetermined orientation in the water when deployed. For example, fishing nets of the “wall” type which are used to surround or guide the fish to be hauled are configured to be suspended substantially vertically in the water, having predetermined upper and lower edge portions. To safeguard the desired orientation, the net is provided with buoyancy and sinking means arranged corresponding to the upper respectively the lower edge portion of the net. The sinking means may be in the form of individually attached weights or, which is normally the case for large scale industrial fishing nets, the sinking means may be provided as a ribbon, band or line like structure supplied in continuous lengths and attached to the lower edge of the fishing net. The present invention primarily addresses the latter type of sinking means for which the term sink line will be used in the following.

To provide the desired relatively high weight, sink lines traditionally comprise a large number of relatively small weights attached to a line formed supporting structure. In the past such weights have almost exclusively been made from lead which in this context has a number of desirable features, e.g. high density providing for small diameter lines, high resistance to corrosion, easily deformable allowing the lead weights to be secured to a supporting line structure by simple squeezing. Further, lead is a relatively inexpensive material.

It is also well known that lead is a very poisonous material, however, due to the above-described advantages and the lack of a suitable replacement material, this major disadvantage has been accepted for decades. However, with the increasing environmental awareness, it has become apparent that lead is no longer acceptable and should be replaced with more environmentally safe materials.

An attempt to replace lead has been made by using zinc instead, however, zinc is inferior to lead on most of the above points. For example, zinc is lighter having a density of 7.13 g/cm² compared to 11.35 g/cm² for lead, just as it is much more brittle making it complicated to attach the individual weights on the supporting line structure. Further, in an aggressive environment as salt water zinc will corrode to a certain degree thus diminishing the expected life of a zinc-based sink line. A further disadvantage of zinc is the much higher cost. In addition to zinc, also cobber and pewter may be considered, however, they are even more expensive just as cobber is also a poisonous material.

Turning to cheaper materials such as steel or iron materials (i.e. including alloys thereof), these materials have a density higher than zinc, e.g. 7.87 g/cm² for pure iron, however, they will corrode heavily in salt water which means that they will have to be coated in some way to protect the material from contact with the salt water. Although such a coated iron material as such would be acceptable as a replacement for lead, it would be difficult to properly secure such a coated iron weight to the supporting line structure for a number of reasons. For example, in order to allow the weight to be threaded onto a line, the weights had to comprise a through going opening which would be difficult to properly coat, and in case it was desirable to squeeze the weight onto the line, the coating would most likely crack allowing salt water to reach the iron material.

On a much smaller scale, U.S. Pat. No. 6,221,309 relates to a non-lead based weight intended for leisure fishing purposes only. More specifically, a method for manufacturing a fishing weight which prevents environmental pollution is disclosed, including the steps of moulding the fishing weight with a ceramic material and subsequently heating the moulding material up to a predetermined temperature to convert the heated material into a pure earth material. It readily appears that such weights would be extremely expensive and thus unsuitable for large-scale commercial use.

Similarly, U.S. Pat. No. 5,648,121 discloses a coated zinc weight comprising an opening allowing it to attached to the end portion of a fishing line used for leisure purposes, however, the disclosed weight would be unsuitable for being secured to a supporting line for industrial fishing purposes.

### SUMMARY OF THE INVENTION

Having regard to the above discussion, it is the object of the present invention to provide a sink line suitable for attachment to a fishing net, which is environmentally friendly and can be manufactured to a cost making it economically acceptable as a replacement for lead-based sink lines.

The present invention is based on the realisation that by “separating” the attachment and weight functions of the individual weights, it is possible to provide a sink line in which the individual weights can be manufactured cost-effectively yet being well protected against corrosion.

More specifically, in accordance with the invention a sink line is provided comprising a plurality of weights attached to a longitudinal supporting structure, preferably in a spaced apart relationship, the weights comprising a core member of a first material entirely enclosed in a coating of a second material, the weights having an outer surface in securing engagement with the supporting structure.

In a preferred embodiment the supporting structure has a tube like configuration, the weights being arranged inside the tube in a row-like fashion, the inside surface of the tube being in securing contact with the outer surface of the weights.

Preferably the core member of the individual weights are formed without any openings or deep depressions, this allowing the coating to be applied without the risk of leaving imperfections in the coating. This said, the core members may have any desirable configuration such as round, oval or oblong having any desirable cross-sectional configuration, however, in preferred embodiments the core member is formed as a cylindrical body with a circular cross-section. The core members may in principle be manufactured from any desirable material with a “suitable” high density, however, having regard to the combined requirements of high density and low costs, metals and alloys would be a first choice. For example, alloys based on zinc having a density of 7.13 g/cm² and iron having a density of 7.87 g/cm² would be suitable materials, however, given the lower cost of iron alloys these are preferred.

The dimensions for the core members may be varied according to the desired properties of the sink line, e.g. the weight per unit of length and the thickness (e.g. diameter) for the line. For example, a given weight per unit of length may be achieved either by small diameter members arranged with minimal spacing or by larger diameter members arranged with greater spacing. The spacing between the individual weights should be chosen to give the finished sink line the desired flexibility, i.e. when the weights are arranged very closely, they will abut against each other corresponding to a “stiff” line having a large bending diameter. Further, when the coated weights often come in contact with each other, the coating will be subject to heavier wear. This said, the definition that the weights are arranged in a specified spaced apart relationship includes the case in which some or all of the weights are arranged with zero spacing. If deemed necessary, additional means may be placed between the coated weights to prevent contact therebetween (e.g. made from a foam material providing minimal resistance to compression) or the tube surrounding the weights may be arranged to fully enclose the weights.

The coating may be made from any suitable material providing the desired corrosion protection of the core material in salt water, as well as having the necessary strength to withstand external influences including both chemical degradation (e.g. corrosion) and mechanical wear. Having regard to these requirements, coatings of plastic materials are preferred, such material being relatively inert in salty seawater, yet providing a coating which is both elastic and hard-wearing. Further, the coating material should be suitable for a large-scale complete coating process (i.e. openings and similar imperfections would not be acceptable) of relative small core members in a cost-effective manner. A suitable and presently preferred coating material is Rilsan ® manufactured and distributed by Atofina, for example as Rilsan PA 11.

To provide a certain frictional “grip” between the supporting structure and the outer surface of the individual weights, the surface may be provided with gripping means in the form of, for example, a textured surface or by a coating providing a certain roughness, e.g. as Rilsan when applied without post-fusion. In addition to improving the grip between the supporting structure and the weights, a rough or textured surface on the core members would also improve handling thereof during the manufacturing. Preferably the actual roughness for the weights is chosen corresponding to the gripping capabilities of the supporting structure, i.e. to provide a matching pair of surfaces having a good grip, this including an outer surface ranging from smooth to a surface comprising projecting spike means.

In principle, the weights may be arranged in a pre-manufactured tube structure, however, for large-scale production of sink lines in “endless” lengths, this approach would not be applicable. Therefore, corresponding to a second aspect of the invention, the sink line of the invention is manufactured by establishing a tubular structure “around” the weights.

Such a tubular structure may be provided in any suitable manner, including braiding, weaving or knitting a “stocking” around the weights, fusing or assembling one or more sheets together along one or more lines, or directly extruding a tubing around the weights.

As it is well known to braid or knit a stocking around a longitudinal structure such as a rope, it would be possible to use existing braiding or knitting machinery in combination with equipment advancing the weights in the desired pattern, i.e. at the desired speed and with the desired spacing. Preferably the tubular structure is applied closely around the individual weights thereby essentially locking them in position. By “essentially locking” is meant that the weights will not move noticeable during normal use, but that minor movement can be allowed, for example when bending the sink line.

When “assembling” a tubing around the weights, preferably a single ribbon or band is folded in a U-like configuration around the weights, the free side edges thereafter being attached to each other, for example by stitching when using a fabric or by heat fusion when using a meltable material such as a thermoplastic foil.

When using an extrusion process, a heat shrinkable polymer may be extruded around weights forwarded through an opening arranged within the opening of the extrusion die, after which the extruded tubing, if desirable, may be heat-shrink around the weight to thereby improve the gripping engagement.

The weights may be supplied in the desired pattern to the tube-providing means by any suitable means. For example, the weights may be supplied by mechanical means “positively” gripping or holding the weights with the desired spacing, or they may be fed by controlled streams of air.

In the above a “basic” configuration of a tubular sink line has been described in detail, however, in accordance with the invention, such a sink line may be used in combination with additional structures providing a line assembly which has been specifically adapted to suit specific needs.

In a preferred embodiment the sink line is provided with protruding attachment means allowing the line to be easily attached to a lower edge portion of a fishing net. The attachment means may be formed integrally with the “primary” tubing surrounding the weights or it may be provided as an additional structure.

For example, during braiding or knitting of the primary tubing, the process may be controlled to directly form protruding attachment means, or when stitching together a band of fabric an over-lock seam portion may form an attachment rim portion running along the length of the tubing.

Further, a second tube having an “oversize” diameter may be provided around the primary tube in a similar manner as described above, the second tube subsequently being stitched together to both grip the inner tubing as well as forming an attachment boarder running along the length of the tubing.

In order to be able to vary the weight per unit of length in a cost-effective manner, two or more sink lines may be combined to an assembly, just as reinforcing means such as a robe structure may be incorporated in the line. The different members of the assembly may be hold together by any suitable means, preferably using tube structures as defined above with or without attachment means integrally formed therewith.

### BRIEF DESCRIPTION OF THE DRAWINGS

In the following the invention will be further described with references to the drawings, wherein

FIG. 1 shows a first embodiment of a sink line,

FIG. 2 shows a cross-sectional view of the sink line of FIG. 1,

FIG. 3 shows a cross-sectional view of a second embodiment of a sink line,

FIG. 4 shows a cross-sectional view of a third embodiment of a sink line,

FIG. 5 shows a cross-sectional view of a fourth embodiment of a sink line,

FIG. 6 illustrates a first preferred method of manufacturing a sink line in accordance with the invention,

FIG. 7 shows a specific arrangement for a first manufacturing machine of the type illustrated in FIG. 6,

FIG. 8 shows a specific arrangement for a second manufacturing machine, and

FIG. 9 shows a cross-sectional view of sink line corresponding to a manufacturing step.

### DESCRIPTION OF THE PREFERRED EMBODIMENTS

In the description of the figures it is to be noticed that they are not drawn to scale just as they are only schematic serving to illustrate the principles of the invention. For example, many structures such as the tube and the weights are shown arranged at a distance from each other although they in the finished product are in contact with each other. Further, in the figures the same reference numerals are used to denote like structures.

FIG. 1 shows a first embodiment of a sink line 1 in which a number of individual weights 10 are arranged inside a tubular structure 20 in a linear configuration with a space 11 therebetween. The individual weights have a cylindrical rod like configuration each comprising a core member 12 enclosed in a coating 13 defining an outer surface having a circumferential portion 14 as well as end portions 15. The tubular structure (or just tube) comprises an inner surface 21 which engages the circumferential portion of the weights corresponding to a first diameter thereby providing a frictional grip. Corresponding to the spaces between the weights the tube comprises narrowed portions 22 with a smaller diameter which partially engages the end portions of the weights, thereby enhancing the grip and preventing the weights from substantially moving inside the tube.

In the preferred embodiment the core members are made from a lead-free iron alloy (in the following termed iron) having a density of approximately 7.87 g/Cm² as compared to 11.35 g/cm² for lead which means that for the same weight per unit length of the core member, a diameter being 1.44 times larger has to be used. This means that for lead weights having diameters of for example 3, 4 or 6 mm it would be necessary to use iron members with corresponding diameters of 4.3; 5.76 and 8.64 mm which normally would be fully acceptable. Apart from this, the diameter and length of the core member as well as the distance therebetween inside the tube may be chosen in accordance with the desired specification for the sink line.

Preferably the coating is made from Rilsan ® providing an elastic coating with excellent capabilities for withstanding the salt-water environment. Further, Rilsan ® can be applied using a method leaving a relatively rough surface improving the grip between the weights and the tube. Basically the method comprising the steps of heating the core members and mixing them with Rilsan ® in granular form, the latter melting onto the surface of the members in a “dot-like” fashion fully covering the surface, thereby providing a rough surface which may have a roughness R of 10-50 μm, typically around 20 μm.

The tube may be of a fabric or a polymer material as discussed in greater detail below.

FIG. 2 shows a cross-section of a sink line as shown in FIG. 1. The tube may be a braided, woven or knitted structure, or it may be a heat-shrunk polymer.

FIG. 3 shows an embodiment in which the tube has been assembled around the weights by folding a longitudinal band in a U-like configuration around the weights, after which the free side edge portions 23, 24 have been attached or connected to each other along an attachment line, for example by stitches 25 when using a fabric or by heat fusion when using a meltable material such as a thermoplastic foil. As appears, the connected portions form a longitudinal, protruding flange-like structure which may serve as an attachment means running along the length of the sink line, allowing, for example, the sink line to be stitched to a lower portion of a fishing net.

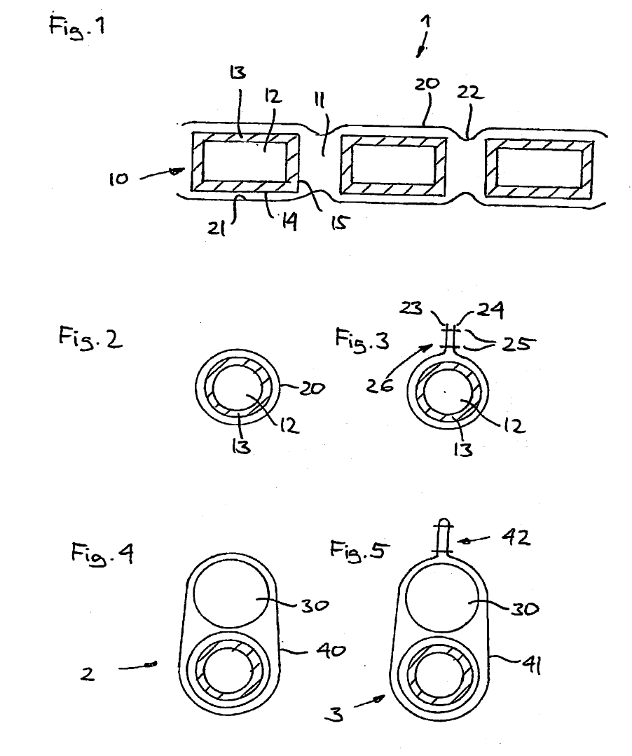

FIG. 4 shows a sink line assembly 2 in which a reinforcing means in the form of a robe 30 has been attached to the sink line 1. As appears, the sink line and the robe have been connected to each other by a further (or outer) tubular structure 40 enclosing the sink line and the robe, thereby tightly holding the two structures together. The outer tube 40 may be of the same or a different configuration as compared to the inner tube 20 of the sink line.

FIG. 5 shows a sink line assembly 3 substantially corresponding to FIG. 4, the difference being that the outer enclosure is provided by an outer tube 41 having an “over-size” diameter, the additional material being stitched together to provide protruding attachment means 42. It would also be possible to provide a longitudinal attachment means as shown in FIG. 3, just as it would be possible to provide the embodiment shown in FIG. 3 with an outer tube having “over-size” diameter, the additional material being stitched together as shown in FIG. 5 thereby forming a flange.

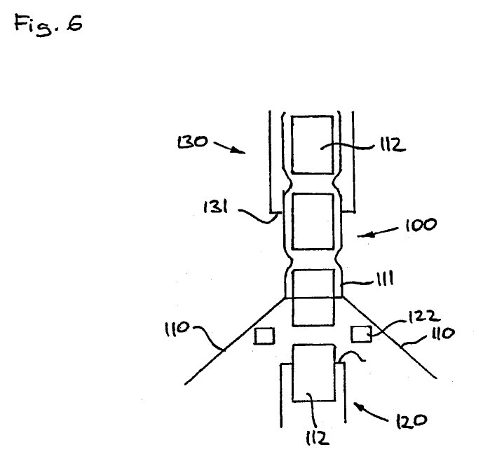

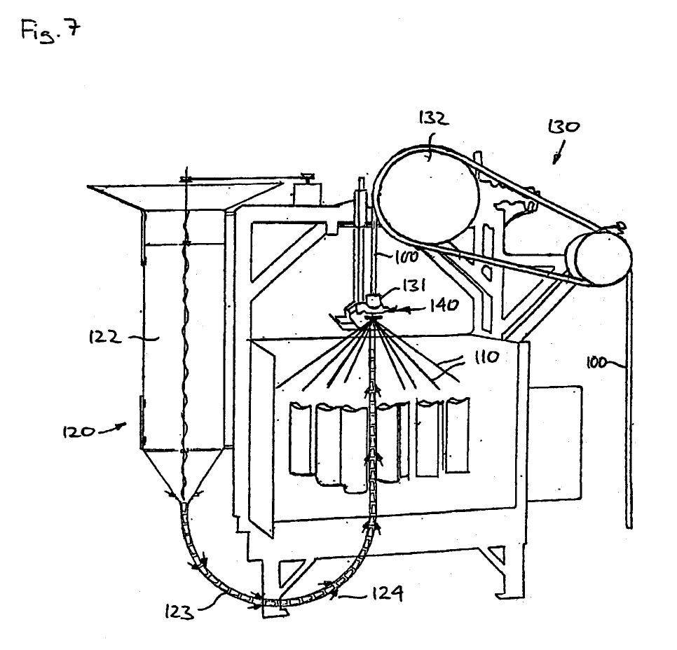

With reference to FIG. 6 a first preferred method of manufacturing a sink line in accordance with the invention will be described. More specifically, a sink line 100 of the same general configuration as shown in FIG. 1 is manufactured using a braiding machine (not shown) in which individual threads 110 are braided to form a tubular structure 111 around coated weights 112. As appears, the manufacturing equipment comprises three basic components: a feeding means 120 having an outlet opening 121 for the weights, a take-up means 130 having an inlet opening 131 for the finished sink line, and a braiding means (not shown).

Preferably the braiding is stationary, i.e. the actual braiding of the individual threads 110 takes place at given position, which means that the feeding means is configured to advance the individual weights at a rate, or speed, (i.e. unit of length per unit of time) corresponding to the rate at which the tube is braided, and with the desired spacing between the weights. The feeding means may be mechanical means in “gripping” engagement with the weights to thereby control the feeding rate, or the feeding may take place by controlling feeding of the weights by air-jets. In this case first air-jets may be used to propel the weights through a tubular feeder, whereas second controllable air-jets 122 providing a transverse air stream may be used to control the spacing between the weights. For example, when a first weight is “gripped” by the braided tube, increasing the transverse air stream would prevent forwarding of a second weight. When the first weight has been fully incorporated into the braided tube and the subsequent tube portion corresponding to the spacing between the weights has been braided, decreasing the transverse air stream would allow the next weight to be forwarded and thereby gripped by the braided tube. The take-up means mainly serves as a support for the just braided tube as well as a means for taking up the braided tube at a rate corresponding to the braiding rate. The braiding means may be any conventional braiding machine, for example a rope-braiding machine as supplied by Herzog, Oldenburg, Germany. The braiding may take place corresponding to a constant diameter of the tube, or the diameter may be varied, for example narrowed corresponding to the spacing between the weights. Correspondingly, also the braiding speed may be varied.

Preferably, the manufacturing equipment can be arranged such that it serves a second purpose as well, e.g. instead of individual weights one or more sink lines and/or supporting means can be fed to the braiding means providing an outer tube as illustrated in FIG. 4. To provide a flange 26 (see FIG. 3) stitching means may be associated with the braiding means providing an over-size tube around the inner tube. Instead of using a second tube, it would also be possible to incorporate a supporting structure, e.g. a robe, within the inner tube, just as it would be possible to attach, for example, a reinforcing structure to the tube just after the braiding process.

FIG. 7 shows a specific arrangement for a manufacturing machine comprising feeding means 120, take-up means 130 and braiding means 140. The feeding means comprises a reservoir 122 for a plurality of coated weights and a conveyer tube 123 with air inlets 124 for propelling the weights, as well as air nozzles (not shown) associated with outlet 121 for controlling the advancement of the weights. The take-up means are provided by reels 132. Without changing the overall configuration of the machine shown, knitting or weaving means may replace the braiding means.

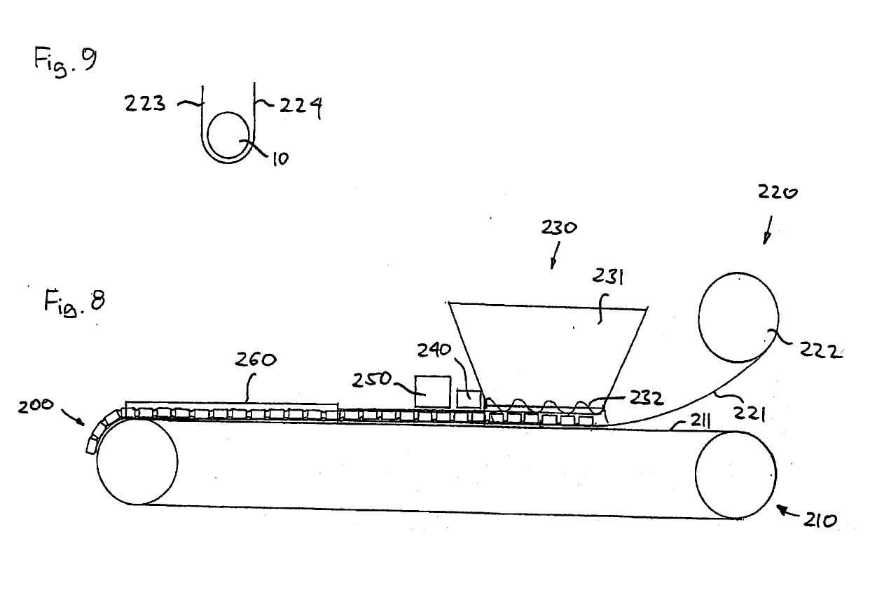

With reference to FIG. 8 a second preferred method of manufacturing a sink line 200 in accordance with the invention will be described, the method being adapted for providing a sink line of the type shown in FIG. 3. More specifically, FIG. 8 shows a specific arrangement for a manufacturing machine comprising transport means 210, first and second feeding means 220, 230, first and second connecting means 240, 250 as well as heating means 260.

The transport means is provided by an endless conveyer belt comprising an upper belt surface 211 on which the sink line is assembled. The first feeding means 220 is arranged to supply a continuous length of a band formed material 221, e.g. a fabric or a polymer foil, onto the upper belt surface, the transport means pulling the band from reels which may be passive or adapted to positively feed the band at a given rate. Before the band passes through the second feeding means, the band is folded in a U-like configuration (by means not shown) with upstanding side edge portions 223, 224 as shown in FIG. 9. The second feeding means 230 comprises a reservoir 231 and a transport snail adapted to place the individual weights onto the U-folded band with a specified spacing. To better arrange the weights with the specified spacing, the U-folded band may pass over indentation means providing a “spacing” action properly locating the weights.

The first connecting means 240 is adapted to bond together the upstanding side edge portions of the band, for example by heat fusing a band made from a thermoplastic polymer, whereas the second connecting means 250 is adapted to stitch together the upstanding side edge portions of the band when the band is made from a fabric. In accordance with the material being used, normally only a single connecting means will be used resulting in a sink line structure as illustrated in FIG. 3. In case the band is made from a heat shrinkable polymer material, the heating means 260 will allow the polymer to shrink around the weights thereby improving the gripping action of the thereby formed tube. The take-up means may be provided by reels (not shown).

The tubular structure surrounding and gripping the weights may also be provided using an extrusion process, wherein a polymer (e.g. heat shrinkable) may be extruded around weights forwarded through an opening arranged within the extrusion die opening, after which the extruded tubing, if desirable, may be heat-shrinked around the weights to thereby improve the gripping engagement. In order to feed the weights into the extrusion tool at the desired rate and with the desired spacing, the weights may be attached to a carrier structure. Such a carrier structure may be in the form of a continuous length of a band or ribbon material onto which the weights are arranged and hold in place, for example by adhesive means.

It is clear that such a carrier structure may also be used in combination with the above-described methods of manufacturing a sink line in order to provide the weights in the desired pattern, such a carrier making the process more “robust” as the individual weights will not be able to be dislocated during the tube-forming or enclosing steps.

In the above description, only sink lines of a tubular configuration have been specifically described, however, it is within the scope of the present invention, that the individual weights may be attached to a supporting structure in a “discrete” way. For example, the individual weights may be bonded to a robe-like supporting structure by adhesive means or by individual tubes gripping around one or more weights and the supporting structures. The latter configuration would be applicable for relatively large weights.

While in the foregoing different embodiments of the invention have been disclosed in detail for purpose of illustration, it will be understood by those skilled in the art that many of these details may be varied without departing from the scope of the present invention as defined in the accompanying claims.

I claim:

1. A sink line (1) comprising a plurality of weights 910) and a longitudinal supporting structure (20), the weights being attached to the supporting structure, preferably in a spaced apart relationship, the weights comprising a core member (12) of a first material entirely enclosed in a coating (13) of a second material, the weights having an outer surface 914) in securing engagement with the supporting structure.

2. A sink line as defined in claim 1, wherein the supporting structure has a tube like configuration, the weights being arranged inside the tube in a row-like fashion, the inside surface (21) of the tube being in securing contact with the outer surface of the weights.

3. A sink line as defined in claim 1, wherein the first material is a metal or metal alloy, and the second material is a polymer.

4. A sink line as defined in claim 1, wherein the core members have a generally cylindrical form arranged in an end-to-end relationship.

5. A sink line as defined in claim 1, wherein at least a portion of the weights has a textured or rough outer surface.

6. A sink line as defined in claim 1, wherein the supporting structure is in the form of a braided, woven or knitted tubular stocking (111).

7. A sink line as defined in claim 1, wherein the supporting structure is in the form of a one or more longitudinal bands (41, 221) assembled along one or more connecting lines thereby forming a tubular structure.

8. A sink line as defined in claim 7, wherein two free edges (23, 24) of the band(s) are connected to each other providing a protruding attachment means (26) running along the length of the tubular structure, preferably in the form of a fabric being stitched together.

9. A sink line as defined in claim 1, wherein an outer enclosing tube structure (40, 41) is formed around the sink line, preferably comprising protruding attachment means (42).

10. A sink line assembly comprising a sink line as defined in any of the previous claims, in combination with at least one more sink line(s) or a reinforcing member (30).

11. A sink line assembly as defined in claim 10, wherein the sink line(s) and/or reinforcing member are attached to each other by a further enclosing tube like structure (40).

12. A sink line assembly as defined in claim 10, wherein the further tube is configured in the form of a braided, woven or knitted tubular stocking (111).

13. A method for manufacturing a sink line, comprising the steps of:
continuously supplying individual weights (112), the weights comprising a core member of a first material entirely enclosed in a coating of a second material,
continuously forming a tubular structure (111) around the weights,
controlling the supplying and forming steps such that the weights are arranged inside the tubular structure in a specified spaced apart relationship.

14. A method as defined in claim 13, wherein the tubular structure is formed by braiding or knitting, the inside surface of the tubular structure beign in securing contact with an outer surface of the weights.

15. A method as defined in claim 13, wherein the tubular structure is formed by extruding a heat-shrinkable polymer tube, the method comprising the further step of subjecting the tube to heat, the inside surface of the tubular structure thereby engaging the outer surface of the weights in a securing contact.

16. A method for manufacturing a sink line, comprising the steps of:
continuously supplying a band formed material (221),
continuously supplying individual weights onto the band in a spaced apart configuration, the weights comprising a core member of a first material entirely enclosed in a coating of a second material,
continuously forming a tube around the weights from the band, such that the weights are arranged inside the tube in a specified spaced a part relationship.

17. A method as defined in claim 16, wherein the band is formed from a fabric formed into a tube by stitching together free edge portions (223, 224) of the band; or wherein the band is formed from a heat-shrinkable polymer material formed into a tube by bonding together free edge portions of the band followed by a heating step.

18. A method as defined in claim 12, wherein a further enclosing tube structure is formed around the sink line, preferably comprising protruding attachment means.

19. A method as defined in claim 18, wherein at least a further sink line and/or a reinforcing member are/is enclosed within the further tube structure.

20. A method as defined in claim 12, wherein the weights are supplied attached to a continuous carrier structure.
